(19) United States
(12) Patent Application Publication
(10) Pub. No.: US 2015/0347081 A1
(43) Pub. Date: Dec. 3, 2015

(54) AUTOMATED AUDIO FLOOR MAT

(71) Applicant: Lawrence Curcio, West Palm Beach, FL (US)

(72) Inventor: Lawrence Curcio, West Palm Beach, FL (US)

(21) Appl. No.: 14/291,238

(22) Filed: May 30, 2014

(51) Int. Cl. G06F 3/16; G08B 3/10

(52) U.S. Cl. CPC G06F 3/165; G08B 3/10

(57) ABSTRACT

An audio floor mat that includses: a top surface; a plurality of pressure sensors within the floor mat; and an audio player, where the audio player emits an audio clip upon activation by the pressure sensors. In one embodiment the top surface may include a sports related logo. The audio player includes at least one speaker and may include a removable media chip where the media chip stores a plurality of audio clips. The audio player may further include a battery storage area to store batteries which provide power for the audio player.

### BACKGROUND OF THE INVENTION

1. Field of Invention

The present invention relates to a floor mat with automated audio features.

2. Description of Related Art

Floor mats are used in various applications as a means to collect soil and dirt from shoes of any users. Floor mats are usually placed at doorways prior to entry into a building and may be used within the building such as in bathrooms or over heavy foot traffic areas. The typical floor mat is usually rectangular in shape, includes a flat surface and may include a fairly abrasive surface for removal of dirt and debris from user's shoes. Because of the wide use of floor mats various styles are available for use. Further some floor mats include a particular style associated with the user's preference such as an artistic display, a particular logo or in certain instances includes text that's across the surface of the mat. Floor mats therefore are available in various styles and textures as needed by the user.

### SUMMARY OF THE INVENTION

The present invention relates to an audio floor mat that includses: a top surface; a plurality of pressure sensors within the floor mat; and an audio player, where the audio player emits an audio clip upon activation by the pressure sensors. In one embodiment the top surface may include a sports related logo. The audio player includes at least one speaker and may include a removable media chip where the media chip stores a plurality of audio clips. The audio player may further include a battery storage area to store batteries which provide power for the audio player.

### BRIEF DESCRIPTION OF DRAWINGS

FIG. 1 depicts a surface floor mat in accordance with the present invention.

FIG. 2 provides a side view of an audio player used in association with the floor mat of the present invention.

### DETAILED DESCRIPTION

The present invention relates to a logo-themed floor mat that includes automated audio play associated with the floor mat. The top surface of the floor mat according to present invention includes a particular logo theme and preferably a sports team-related logo. Further the mat includes a series of sensors within the mat that alerts or triggers an audio player to play music that may be associated with the particular team logo that's displayed over the top surface of the floor mat. The present invention provides an opportunity for individuals to have paraphernalia related to the particular sports team and audio messaging associated with the mat that normally may be associated with the sports team in one manner or the other.

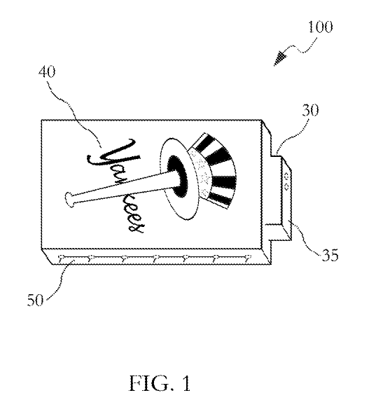

In reference to FIG. 1, an Audio Mat 100 is depicted. The Audio Mat 100 includes a top surface 40 that may be adored with a team logo as shown. The team logo may be associated with any professional, college or high school sports team. The logo is across the top surface 40 and provides an identifying association.

The Audio Mat 100 further includes a housing 50 within the Mat 100. The housing 50 includes an audio chip 20, which stores an audio message or music associated with the team logo displayed on the top surface 40. The audio message or music may then be played through speakers 35 upon activation. Activation of the audio message or music is accomplished through sensors, not shown, within the Audio Mat 100. The sensors detect weight of any user standing or at least stepping onto the surface 40 of the Mat 100. The sensors are connected to the audio chip 20 via a wiring clip 37. Further batteries 22 are provided that supply power to the audio chip 20 and speakers 35. The mat 100 may be placed at any threshold of a door thus alerting any visitor of the owner's affiliation or fascination with the particular team displayed on the top surface 40.

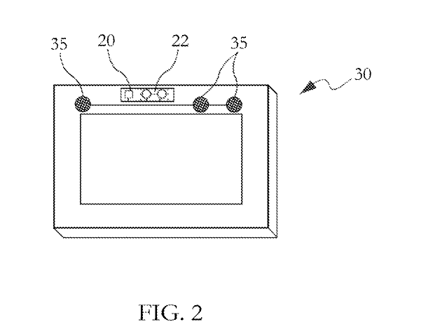

FIG. 2 depicts a side view of the audio chip 20 along a side 45 of the Audio Mat 100. The speakers 35 are placed on each side of the audio chip 20. The audio chip 20 and batteries 22 are encase within the housing 50. By using control mechanisms, the user may select audio clips saved on the audio chip 20 as shown in FIG. 2. During operation this particular mat according to the present invention will activate the audio message upon the triggering of the pressure sensors within the Audio Mat 100. The instant invention has been shown and described in what it considers to be the most practical and preferred embodiments. It is recognized, however, that departures may be made there from within the scope of the invention and that obvious modifications will occur to a person skilled in the art.

What is claimed is:

1. A audio floor mat comprising:
a. a top surface;
b. a plurality of pressure sensors within the floor mat; and
c. an audio player, where the audio player emits an audio clip upon activation by the pressure sensors.

2. The audio floor mat according to claim 1, where the top surface includes a sports related logo.

3. The audio floor mat according to claim 1, where the audio player includes at least one speaker.

4. The audio floor mat according to claim 1, where the audio player includes a removable media chip where the media chip stores a plurality of audio clips.

5. The audio floor mat according to claim 1, where the audio player includes a battery storage area to store batteries which provide power for the audio player.
